(19) United States
(12) Patent Application Publication
(10) Pub. No.: US 2008/0311468 A1
(43) Pub. Date: Dec. 18, 2008

(54) Optimized cooling tube geometry for intimate thermal contact with cells

(76) Inventors: Weston Arthur Hermann, Palo Alto, CA (US); Scott Kohn, Menlo Park, CA (US); Gene Berdichevsky, Palo Alto, CA (US)

Correspondence Address: Michael T. Raggio;Raggio & Dinnin, P.C., Ste. 410, 2701 Cambridge Court, Auburn Hills, MI, 48326, US

(21) Appl. No.: 11/820,008

(22) Filed: Jun. 18, 2007

(51) Int. Cl. H01M 10/50

(52) U.S. Cl. 429/120

(57) ABSTRACT

A battery pack thermal management system for use in an electrical vehicle is disclosed. The battery pack thermal management system includes a manifold and a plurality of cells arranged in a predetermined pattern within the battery pack. The system also includes a cooling tube having a scallop like outer surface in thermal contact with the cells and in fluid communication with the manifold. The thermal management system will cool the battery pack to a predetermined temperature to increase the longevity of the battery pack within the electric vehicle.

### BACKGROUND OF THE INVENTION

1. Field of the Invention

The subject invention generally relates to a thermal management system and more particularly relates to optimized cooling tube for use in a thermal management system in an electric vehicle.

2. Description of Related Art

It is well known in the prior art to use all electric automobiles to provide transportation for occupants. Many of these prior art electric automobiles carry several thousand pounds of nickel metal hydride batteries to achieve a long range electric vehicle for every day use by consumers. Furthermore, many of these prior art electric vehicles need to be physically large and heavy to accommodate all of these batteries, such that these cars are not capable of achieving necessary acceleration, handling, performance and an extended range needed for an electric car to become a feasible option for public purchase and use. Many prior art electrical vehicles are of normal size and not overly heavy in a very small range, thus reducing feasibility for large mass selling of such vehicles to the consuming public. Furthermore, many of these prior art electric vehicles have problems with protecting the occupants in the vehicle from the high voltage components and high temperatures that emanate from such high voltage components and still provide a vehicle at acceptable speeds comparable to that of a gasoline or diesel internal combustion engine. Many of these prior art electrical vehicles have had problems with the prior art batteries overheating, thus reducing the range of the electric vehicle and the durability and overall life of the batteries or cells that are part of the battery pack systems within the electric vehicle.

Generally, the battery or cells arranged within many prior art vehicles operate with high power output which increases the temperature and hence, may reduce the longevity of the prior art batteries. The use of the heavy and high voltage batteries from prior art electric cars required a lot of maintenance to keep the batteries operating due to the high temperatures at which the battery pack systems operated. Some of these prior art systems tried to maximize longevity of the batteries by using air cooled systems that would blow cold air over the batteries to try and remove heat from the battery compartment and batteries in these prior art electric vehicles. However, many of these prior art heat reduction systems for the batteries were not efficient and did not provide efficient systems for thermally balancing the batteries. Hence, some prior art systems may have suffered from overheating or over cooling thus reducing the durability and longevity of the batteries, and hence the range of the electric vehicle. Generally, if these prior art vehicle batteries got too hot, it may have reduced the batteries longevity and the ability to hold a charge and in turn reducing the range of the electric vehicle and the overall feasibility for selling such electric cars to the consuming public.

Therefore, there is a need in the art for an improved battery pack thermal management system for use in an electric vehicle. There also is a need in the art for a thermal management system that will use optimized cooling tube geometries to optimize thermal contact with cylindrical battery cells. There is also a need in the art for a thermal management system that will thermally connect each of the cells and the battery pack thereby thermally balancing the overall battery pack system. There also is a need in the art for a thermal management system that will increase the maximum longevity, efficiency and power that can be extracted from the batteries, thus increasing the range of the electric car for the consumer. There also is a need in the art for a cooling system that may help prevent propagation of thermal runaway. There also is a need in the art for optimized geometry cooling tube that will allow for more energy to be carried for a given module size and weight. There also is a need in the art for a scalloped cooling tube geometry that would decrease thermal resistance and allow for a higher power operation and shorter warm up time.

### SUMMARY OF THE INVENTION

One object of the present invention may be to provide an improved battery pack thermal management system.

Another object of the present invention may be to provide a scalloped cooling tube for use in a thermal management system for use in an electric vehicle.

Still another object of the present invention may be to provide a scalloped cooling tube geometry that will allow for more energy to be carried for a given battery module size and weight.

Yet another object of the present invention may be to provide a thermal management system that has scalloped cooling tubes that may decrease thermal resistance by a factor of two, thus allowing for higher power operation and shorter warm up times as well as having increased protection against thermal runaway propagation.

Yet another object of the present invention may be to provide scalloped cooling tubes that will allow for utilization of space between rows of nesting battery cells, thus providing an optimum geometry for increased performance of the battery pack.

Yet another object of the present invention may be to provide improved energy density by decreasing the axial pitch between rows of cells by a predetermined number over other cooling tube configurations due to the closer nesting of cells with one another.

Still another object of the present invention may be to provide an increase in volumetric energy density and the removal of excess packaging and thermally conductive media from between the cells and the cooling tube.

Still another object of the present invention may be to provide a scalloped cooling tube that will provide a two dimensional patch of minimum separation by contouring circumferentially around each cell on both sides of the cooling tube.

Still another object of the present invention may be to use a thermally conductive medium between the cell and scalloped cooling tubes.

Still another object of the present invention may be to provide mitigation and possible prevention of propagating thermal runaway between cells via the use of the optimized cooling tube geometry.

To achieve the foregoing and other objects, a battery pack thermal management system for use in an electric vehicle is disclosed. The system includes a manifold and a plurality of cells arranged in a predetermined pattern within the battery pack. The system also includes a cooling tube having a scalloped like outer surface in thermal contact with the cells.

One advantage of the present invention may be that it provides a novel and improved thermal management system for a battery pack.

Still a further advantage of the present invention may be that it provides an optimized geometry cooling tube for use in an electrical vehicle.

Yet another advantage of the present invention may be that it provides a scalloped cooling tube for use in a thermal management system in an electric vehicle.

Yet another advantage of the present invention may be that it provides a scalloped cooling tube that will allow for more energy to be carried for a given battery module size and weight.

Still another advantage of the present invention may be that it provides a scalloped cooling tube geometry that would decrease thermal resistance by approximately a factor of two and allow for high power operation and shorter warm up times, as well as adding increased protection against thermal runaway.

Still another advantage of the present invention may be that the scalloped cooling tubes improve energy density by decreasing the axial pitch between rows of cells by approximately 10% over other configurations due to the closer nesting of battery cells to one another.

Still another advantage of the present invention may be the use of scalloped cooling tubes with a thermally conductive medium between the tube and the cells thus decreasing thermal resistance by up to a factor of two for a minimum separation distance of approximately 0.5 millimeters with a greater reduction for smaller separation distances.

Still another advantage of the present invention may be higher cell power delivery for longer time periods which may allow for faster warm up time when the cells are being actively heated to a minimum operating temperature for equivalent fluid flow conditions.

Yet another advantage of the present invention may be that it provides a way of thermally balancing the cells of a battery pack, thus maximizing the longevity, efficiency and power that can be extracted from the energy storage system of the electric vehicle.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a manifold connected to an energy storage system (ESS) enclosure according to the present invention.

FIG. 2 shows an energy storage system according to the present invention.

FIGS. 3 A and B shows a top view of a cooling tube having an optimized geometry according to the present invention.

FIG. 4 A-D shows a perspective view, a top view, an end view and a side view of a scalloped cooling tube for use in a thermal management system according to the present invention.

FIG. 5 shows a perspective view of a scalloped cooling tube according to the present invention.

FIG. 6 shows a close up view of a scalloped cooling tube according to the present invention.

FIG. 7 shows a scalloped cooling tube arranged between adjacent rows of cells according to the present invention.

FIG. 8 shows a compressible thermal pad for use with a cooling tube according to the present invention.

FIG. 9 shows a die used to create a scalloped cooling tube according to the present invention.

FIG. 10 shows an alternate embodiment of a die used to make a scalloped cooling tube according to the present invention.

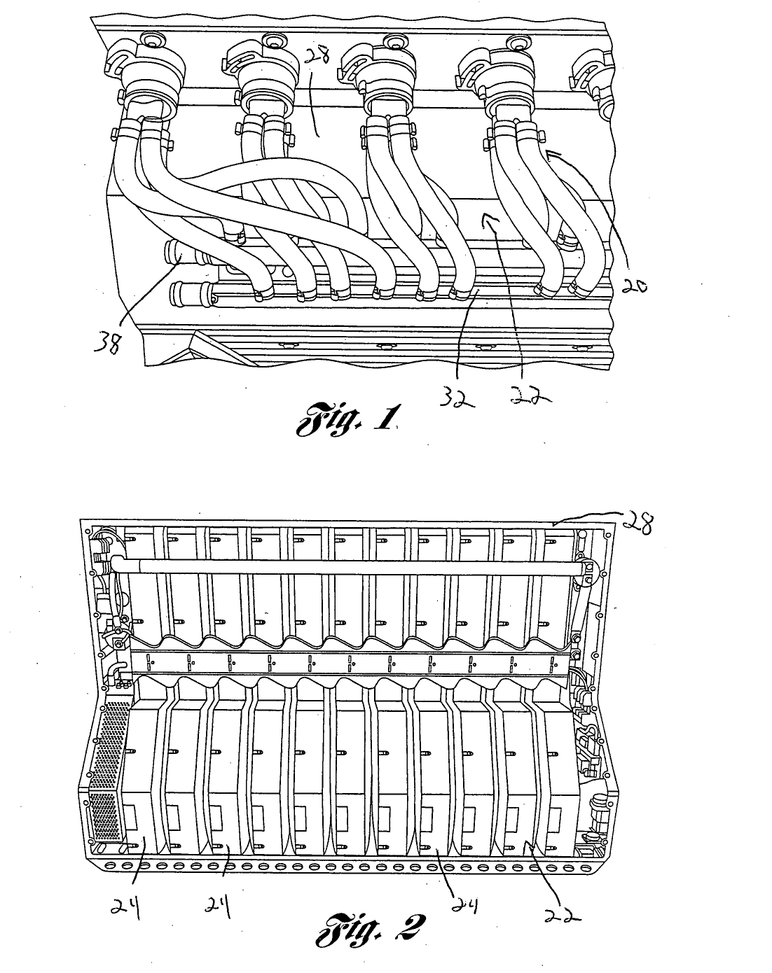

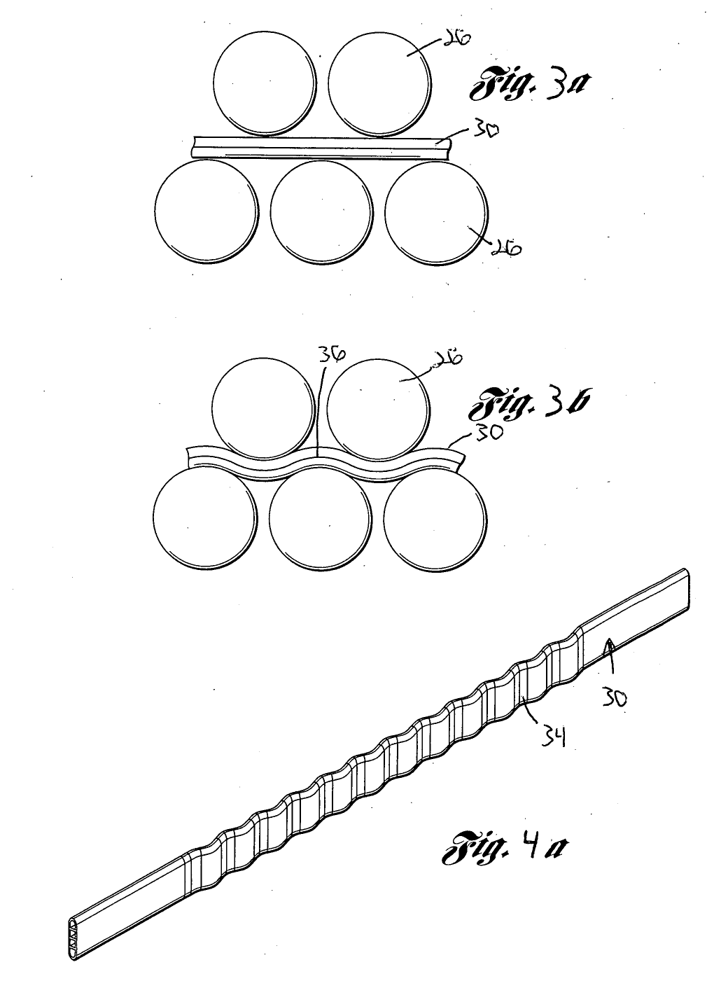

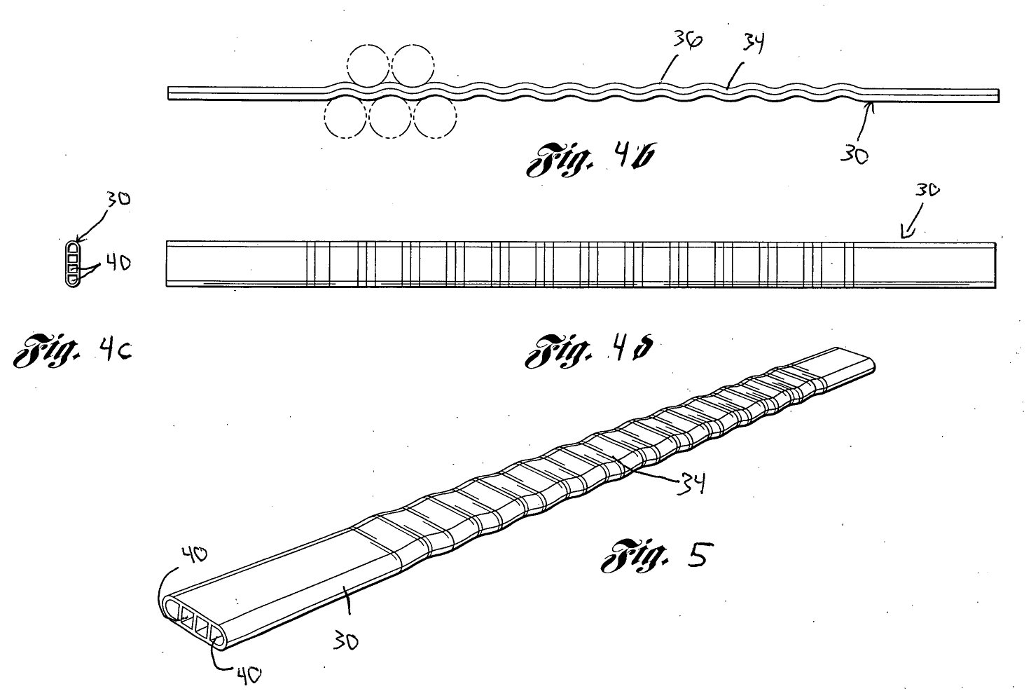

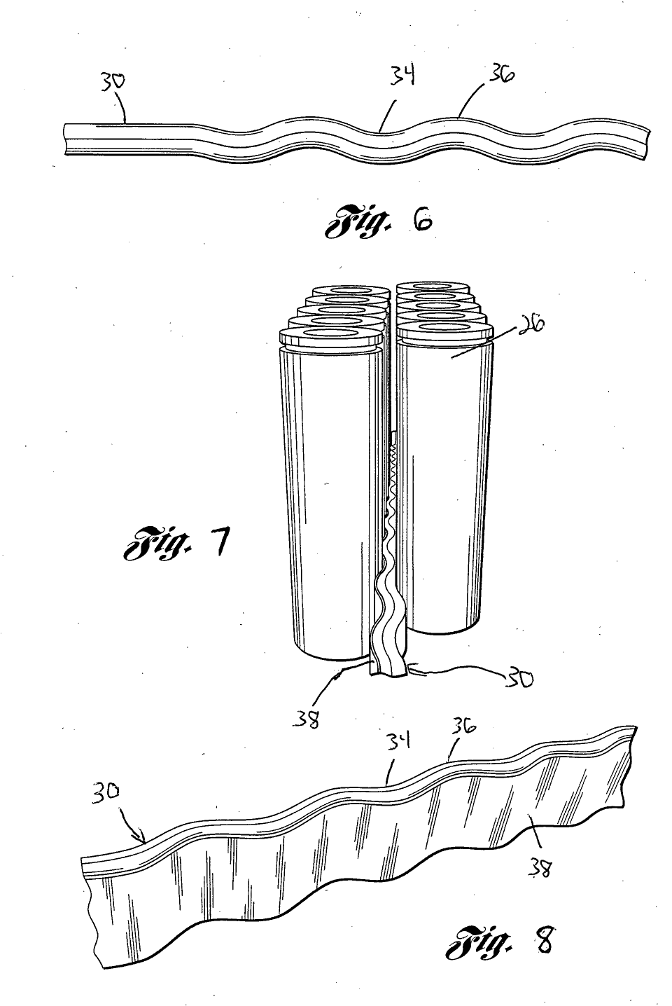

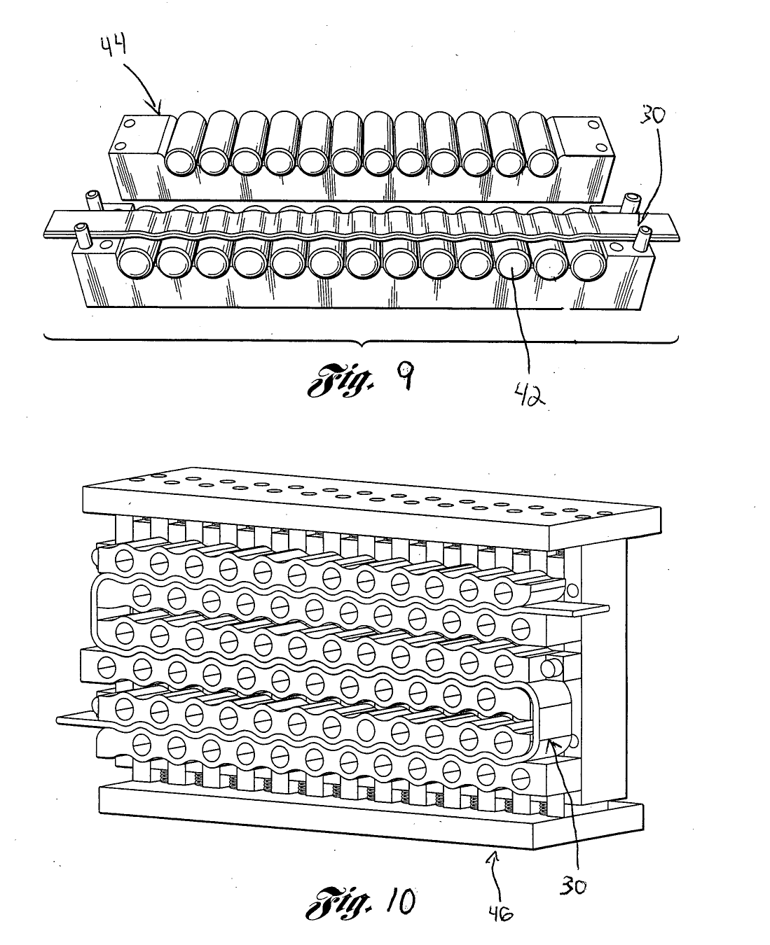

### BRIEF DESCRIPTION OF THE PREFERRED EMBODIMENT(S)

Referring to the drawings, a battery pack thermal management system 20 used with an energy storage system (ESS) 22 is shown. The energy storage system or battery pack 22 is generally comprised of a predetermined number of battery modules or sheets 24, a main control logic PSB, and a twelve volt power supply. In one contemplated embodiment the energy storage system 22 has eleven battery modules or sheets 24 which are capable of producing approximately 375 volts DC. This nominal voltage may operate an electric vehicle that will be capable of traveling many miles without recharging and is capable of delivering enough power and acceleration to compare favorably with internal combustion engines. In one contemplated embodiment, the ESS 22 may be capable of storing enough energy that the electric vehicle can travel approximately 200 miles without recharging. However, it should be noted that it is also contemplated to have an electric vehicle based on the present invention that can travel well over 200 miles without recharge. It is also contemplated in one embodiment that the electric vehicle used in the energy storage system 22 of the present invention will be capable of accelerating at speeds comparable to an internal combustion engine vehicle. No electrical car is known to produce this type of acceleration and mileage range without recharging.

The present invention may use batteries made of lithium ion cells 26, one contemplated embodiment uses commodity 18650 form factor lithium ion cells 26 for the electric vehicle. The batteries 26 of the present invention store the chemical energy equivalent of approximately two gallons of gasoline. The battery pack 22 operates at a nominal 375 volts and delivers approximately 240 horsepower to the motor. The energy and power capabilities of the battery pack 22 allow for the battery pack design and architecture to have many features that ensure the safety of the vehicle and its occupants during use of the electric vehicle. It should be noted that the lithium ion cells 26 are rechargeable such that after recharging, the batteries will be able to provide traction power for the vehicle based on a fully recharged and capable battery. The energy storage system 22 in one embodiment comprises 6831 individual lithium ion cells 26 that may allow it to achieve the drive power and range necessary for the vehicle. These cells 26 are electrically connected in parallel groups of nine cells wherein each of these groups of nine cells constitutes an electric module called a brick.

The bricks are then connected in series within individual battery modules in the energy storage system 22 called sheets 24. Each sheet or battery module 24 is a single mechanical assembly and consists of nine bricks electrically connected in series. It should be noted that it is contemplated that the sheets 24 or cells 26 may be the smallest replacement unit within the energy storage system 22. Each sheet 24 generally has a nominal voltage of approximately thirty five volts DC. Furthermore, each of these sheets 24 contains a mechanical mounting system, battery monitoring hardware electronics, a thermal management or cooling system, as well as various safety systems to ensure proper protection of the vehicle and occupants in such vehicle. In the embodiment contemplated, eleven sheets may be used in total to bring approximately 375 nominal volts DC to the energy storage system for use in the electric vehicle. Each of these sheets 24 will be rigidly mounted within an ESS enclosure 28 and electrically connected to one another in series. It should be noted that the ESS 22 contemplated and shown in the present invention may be adjusted by either increasing or decreasing the number of sheets and/or bricks within the ESS 22.

The high power out of the energy storage system 22 and associated individual cells 26 that comprise the ESS 22 must be thermally managed. This management will increase and maximize the longevity of the energy storage system 22. The temperature of the cells 26 may be managed at the sheet level wherein each of the cells 26 may benefit from the thermal management system 20 regardless of its physical position within the sheet 24. It should be noted that the thermal management system 20 of the present invention maintains each cell 26 within a predetermined temperature range within the energy storage system 22. Furthermore, the thermal management system 20 of the present invention may provide for a method of thermally connecting each of the cells 26 in each sheet 24, thereby thermally balancing each sheet 24. Through the balancing of the sheets maximum longevity, efficiency and power will be capable of being extracted from the energy storage system 22. The thermal management system 20 of the present invention removes heat from the energy storage system 22 to provide a cooling or chilling of the cells 26, thus increasing longevity and range of the electric vehicle on the road. The thermal management system 20 may also be capable of adding heat if the cells require such. It should also be noted that the thermal management system 20 is capable of mitigating or stopping thermal runaway of a battery cell 26 within the energy storage system 22.

The electric vehicle according to one embodiment of the present invention may have a heating ventilation air conditioning (HVAC) comprised of two loops, one for cabin cooling and heating and one for energy storage system 22 cooling and heating. In one contemplated embodiment these two HVAC systems will be independently controlled. However, it should be noted that it is also contemplated to have both systems controlled by one independent controller. The energy storage system 22 may be cooled via its loop by pumping actively chilled coolant or fluid through a cooling tube 30 which is arranged within each sheet 24 of the energy storage system 22. The temperature of this fluid or coolant will be controlled by the HVAC system. In one embodiment the coolant will be chilled using a refrigerant-to-coolant heat exchanger, however it should be noted that any other type of heat exchanger may be used depending on the design requirements of the electric vehicle in which the coolant will be used. Any type of coolant may be used within the system. It should also be noted that the heat exchanger in one embodiment contemplated will be a compact parallel plate heat exchanger wherein the heat is transferred from the coolant to the refrigerant. In this cooling system the coolant will enter and exit each sheet 24 of the energy storage system 22 via a manifold 32. It should be noted that any known HVAC system and/or thermal management device that is capable of either removing heat or adding heat to a cell 26 may be used in the present invention. It is also contemplated to use a coolant to air heat exchanger for the present invention.

The thermal management system 20 according to the present invention is a continuously closed loop control system. The temperatures in the system are monitored at a predetermined number of positions in each sheet 24 of the energy storage system 22. Each sheet 24 within the energy storage system 22 has an individual battery monitoring board related thereto. Each of these battery monitoring boards will report the temperatures of the cells 26 within the sheet 24 along with other data to a battery safety monitor. A vehicle management system may be capable of operating numerous methodologies and algorithms to effectively control the thermal management system 20 and the amount of cooling provided to the cells during numerous operating parameters of the electric vehicle and associated energy storage system 22.

The Applicant has filed a co-pending application that describes a thermal management system in detail and that application is hereby incorporated by reference.

The thermal management system 20 includes a manifold 32 that is fastened to an external surface of the ESS enclosure 28. The manifold 32 is generally a double barreled or cylindrical extrusion. However, any other type or shape of manifold 32 may also be used. The manifold 32 may be in fluid communication with the cooling tube 30 according to the present invention. The manifold 32 may also help the energy storage system 22 to maintain equal flow and hence, uniform temperature control within and among the plurality of cooling tubes 30 through symmetry of pressure gradients across the coolant flow path within the ESS cooling system. The thermal management system 20 of the present invention also includes a novel and improved cooling tube 30 arranged within each sheet 24 of the energy storage system 22. In one contemplated embodiment, the cooling tube 30 has an optimized geometry that will allow for an optimization of volumetric packing density of nested vertically aligned cells 26 within the ESS 22 and also minimize thermal resistant between the cooling tube 30 and the cells 26. It should be noted that the cells 26 generally have a cylindrical shape. The optimized shaped cooling tubes 30 of the present invention may provide for temperature control during operation and mitigation of thermal runaway events within the energy storage system 22 of the electric vehicle. The cooling tube 30 is arranged between adjacent rows of cells 26. The cells 26 may be arranged in rows offset by one half of the cell spacing in a single row. The rows will be capable of nesting together to a desired separation. In one contemplated embodiment, this separation will have a nominal distance of approximately 0.5 millimeters, however any other separation from a few microns up to multiple millimeters is also contemplated for the present invention. The remaining space arranged between cells 26 will be filled by the cooling tube 30 having a specific optimized shape according to the present invention. This will ensure closer contact and closer cell spacing which will have the added benefit of low thermal resistance and a reduced battery pack energy density.

The cooling tube 30 of the present invention has an optimized geometry that generally has a scalloped shape. It should be noted that any other optimized shape may be used, but in the embodiment shown, a scalloped outer shape on the outer surfaces of the cooling tube 30 is used. The scalloped version of the cooling tubes 30 will have a plurality of contours 34 arranged along each side surface of the cooling tube 30. The contours 34 may extend the entire length of the cooling tube 30 or for a predetermined portion of the cooling tube 30. The contours 34 will generally have a predetermined shaped bend arranged along each side of the cooling tube 30. The contours 34 along the surface of both sides of the cooling tube 30 may extend along and against the surface of the cells 26 circumferentially at a constant offset until a point of minimum separation between the cells 26 and the next nesting cell 26 of the opposite row is achieved. The cooling tube 30 then will transition via an inflection or shift 36 and begin to contour around a cell 26 on the opposite row. This practice of contouring and inflecting to maintain minimum separation between the cooling tube 30 and the cells 26 may provide for a maximum thermal proximity along the entire length of opposing rows of cells 26 within the sheet 24. The cooling tube 30 according to the present invention may have a high aspect ratio which may minimize its impact on the axial pitch between the rows of cells 26 and maximize the thermal contact between each cell 26 and the cooling tube 30. It should be noted that the inside radius of each scallop or bend 34 of the cooling tube 30 is approximately equivalent to the outer radius of each cell 26 plus a nominal minimal spacing between the cell 26 and the scallop cooling tube 30.

The cells 26 of the present invention being arranged around the scallop tubes allows for higher density energy storage and higher power operation at lower cell temperatures and/or increased protection against cell to cell propagating thermal runaway. The nesting of the adjacent rows of cells 26 wherein the rows are offset by one half of the cell spacing in a single row, will allow the cooling tube 30 of the present invention to fill up substantially all of the cavity formed by the network of cells 26, thus allowing for a tighter packing of each sheet 24 of cells 26. The geometry of the scalloped tube 30 will allow for the bends 34 to follow the contour of each cell 26, thus providing for a wide area of minimum desired separation ensuring close thermal contact. The size and weight of the battery module 24 is one of the primary limitations for the amount of energy capable of being stored in the electric vehicle. The use of the scalloped cooling tube geometry 30 may allow for more energy to be carried for a given module size and weight within the electric vehicle. Furthermore, the geometry of the scalloped cooling tube 30 may provide benefits to the performance of the energy storage system battery modules 24.

In some cell heat generation conditions including those greater than 1° C. during discharge and during thermal runaway conditions some other geometries may be insufficient to prevent undesirable cell temperatures. During high discharge rates the high thermal resistance between some prior art tubes and cells may result in a requirement to reduce the power output of the battery module. In addition, many of these prior art battery modules that have cooled below their minimum operating temperature may contribute to an unacceptably long warm up period. The scallop cooling tube 30 and any other contemplated optimized geometry may decrease the thermal resistance by approximately a factor of two which will allow for higher power operation and shorter warm up times as well as adding increased protection against thermal runaway propagation according to the present invention. The use of the scalloped tubes 30 may allow for configurations with high energy storage density, a higher degree of safety and the means to maintain the temperature of the cells at moderate levels according to the present invention. The scalloped tube geometry disclosed herein may provide an energy density that is greatly improved by decreasing the axial pitch between rows of cells 26 by approximately 10% over other cooling tube configurations. This 10% decrease is generally due to the closer nesting of the cells 26 to one another. It should be noted that the 10% decrease is an approximation and any other percentage decrease may also be achieved depending on the optimized geometry used for the cooling tubes 30. The scalloped tube geometries also may have a direct impact on the volumetric energy density while also impacting the gravimetric energy density by removing excess packaging and thermally conductive media from between the cells 26 and the optimized geometry cooling tubes 30. It should also be noted that the scalloped tube geometry according to the present invention may provide a two dimensional patch of minimum separation by contouring circumferentially around each cell 26 on both sides of the cooling tube 30. It is also contemplated to use a thermally conductive medium 38 between the cell 26 and scalloped cooling tube 30, which will decrease thermal resistance by up to a factor of approximately two for minimum separation distance of approximately 0.5 millimeters with greater reductions occurring for smaller separation distances. These lower thermal resistances may allow higher cell power delivery for longer time periods in addition to allowing faster warm up time when the cells are being actively heated to their minimum operating temperature for equivalent fluid flow conditions. Furthermore, each scalloped cooling tube 30 may allow for lower thermal resistance which may allow the electric vehicle designers to change the cooling system, for example by changing the coolant refrigerant heat exchanger to a coolant air heat exchanger thus reducing the weight and complexity of the electric vehicle.

It should also be noted that a primary advantage of the optimized cooling tube geometry according to the present invention is the prevention of propagation of thermal runaway from cell to cell within the energy storage system 22. Generally, when an individual cell 26 enters this condition, the heat generated must either be removed by active cooling and/or absorbed by enough surrounding cells to not sufficiently heat any one individual adjacent cell to a point that it also enters thermal runaway. It should be noted that the approximate factor for reduction and thermal resistance between a cell 26 and the scalloped cooling tube 30 generally creates the potential for the mitigation and possible prevention of propagating thermal runaway within the energy storage system 22 by bringing the cells 26 in closer thermal contact with the cooling tube 30 and fluid contained within. Close thermal contact with the fluid may allow for boiling heat transfer to transport heat to many surrounding cells 26 and close thermal contact with the cooling tube 30 may allow heat to conduct down the tube 30 to be absorbed by many surrounding cells 26. If enough surrounding cells 26 absorb the heat generated by the runaway event, the propagation of the event may be halted. It should be noted that the factor of two reductions in thermal resistance is an approximation and the factor may either be larger or smaller depending on the design requirements of the energy storage system. It should be noted that the width of the scalloped cooling tube 30 may be between a half millimeter up to twenty millimeters depending on the design requirement and the energy storage system 22 being used in the electric vehicle. The length and height of the cooling tube 30 may be of any known dimension. The inner radius of the scallops 34 of the cooling tube 30 according to the present invention may be any known size along with the outer radius of the cells 26 may be of any known dimension as long as the inner radius of the scallop 34 of the cooling tube 30 and the outer radius of the cell 26 are approximately equivalent or the same to one another thus allowing for close thermal contact between the cells 26 and the cooling tube 30.

The cooling tube 30 may have a plurality of lumens or channels 40 arranged within the inner bore of the cooling tube 30. The channels 40 allow for coolant to flow through the cooling tube 30 at a predetermined pressure. The channels 40 allow for fluid to flow in opposite directions within the same tube 30. This counterflow allows heat transfer between the opposing fluid flows, presenting a more uniform coolant temperature to the cells 26 and improving the thermal balance of the cells 26 within the sheet 24. In addition, the channels 40 also allow for the cooling tube 30 to be bent in to predetermined shapes without collapsing the tube upon itself.

It should be noted that the tube 30 may be bent into any predetermined shape that will accommodate the predetermined arrangement of the cells 26 and the sheets 24 within the ESS 22. In one contemplated embodiment the cooling tube 30 may have both ends of the tube arranged adjacent to one another and secured within a tube seal plug. On each end of the cooling tube 30 may be an end fitting that will be used to connect the cooling tubes 30 to the manifold 32 via a hose or any other type of connector material. It should be noted that in one contemplated embodiment the scalloped cooling tube 30 is made of an aluminum material. However, it should be noted that any other type of metal, ceramic, plastic, composite or natural material may be used for the cooling tube 30.

The scalloped cooling tube 32 according to the present invention may be manufactured in a number of contemplated embodiments. In one contemplated manufacturing setting a press 44 will be used. The press 44 may have nesting horizontal cylinders 42 arranged in arrays on either side of the cooling tube 30. These horizontal cylinders 42 will serve as dies and will allow for the predetermined scallops or bends 34 to be arranged along both sides of the cooling tube 30. Another contemplated embodiment for creating the scalloped shape cooling tubes 30 would be to feed a straight cooling tube through a pair of rollers that have curved, scalloped and interlocking protrusions extending therefrom. The shape of these protrusions will define the radii of the scallops produced and the spacing of the rollers may be adjustable for tubes of various widths. Still another contemplated embodiment for making the scalloped cooling tubes 30 according to the present invention may involve taking a pre-bent tube 30 and pressing the indentations, bends or scallops in parallel using a die 46 that has several rolls of scalloped surfaces as shown in FIG. 8. This will allow for improved manufacturing tolerances of the bent cooling tube 30 beyond that which may be achievable in tube bending through plastic deformation of the tube in the die. These close tolerances will allow for minimum separation distance between the cells 26 and the scalloped cooling tube 30 to be reduced, thus further improving thermal performance and energy density of the overall battery pack 22. Generally, these methods are performed on cooling tubes 30 that start as flat tubes and have multiple lumens or channels 40 arranged in their inner bore such that collapse of the tube 30 is reduced or completely eliminated. It should be noted that other manufacturing methods are contemplated to create this scalloped cooling tube 30 for use in an energy storage system 22 according to the present invention.

The scalloped cooling tube 30 of the present invention must have optimal thermal contact between both sides of the tube 30 and adjacent rows of cells 26 within the energy storage system 22. In one contemplated embodiment, a deformable thermal pad 38 may be arranged between the scallop cooling tube 30 and the cells 26 on each side thereof. This deformable thermal pad 38 may provide an intimate thermal contact along the entire height of the tube 30 for the full area that the cooling tube is in contact with or wraps around the cells 26. The use of this pad 38 may reduce the need for other thermal transfer media such as potting compound that is contemplated to be used in other contemplated embodiments. It should be noted that it is contemplated to use the pad 38 in conjunction with a potting compound or other thermal transfer media to provide the best thermal transfer between the scalloped cooling tube 30 and the cells 26. The thermal pad 38 may be deformable enough to ensure that a varying gap between the cooling tube 30 and cells 26 will ensure contact between the cell 26 and tubes 30 via the provided compression necessary to utilize the thermal properties of the thermal pad. Such a compressible thermal pad 38 may allow that any dimensional variations within the manufacturing tolerances of the cooling tube 30 or cells 26 may ensure proper thermal connection between the cells 26 and the scalloped cooling tube 30. It is also contemplated to have the pads 38 secured to the cooling tube 30 via a plurality of outward extending members or catches extending from the surface of the cooling tube 30 which will interact with and hold the thermal pad 38 at a predetermined position with relation to the outer surface of the cooling tube 30. It is also contemplated to use an adhesive or other type of fastening compound to secure the thermal pad 38 to the side of the cooling tubes. It is also contemplated for the cooling tube 30 to be used in association with the thermal pad 38, wherein the thermal pad 34 may have one side cured to a smooth non-sticky surface or have one side coated with a laminate that is electrically insulating to provide electrical isolation and the appropriate thermal contact between the cell 26 and cooling tubes 30. It should be noted the thermal pad 38 may be used on one side, both sides, or neither side of the cooling tube 30 according to the present invention.

It should be noted that the scalloped cooling tube geometry that is shown in the drawings is only one of many contemplated embodiments for an optimized tube geometry that will be capable of filling any shaped gap between any shaped array of nested battery cells 26 within the energy storage system 22. Other contemplated embodiments for optimized tube geometries may include a cooling tube that is hydro formed into a void resembling the rows of cells arranged within each sheet 24 which would provide similar benefits to the scallop cooling tube 30 of the present invention and may allow for high tolerances. Still another contemplated optimized tube geometry may be a cooling tube formed in a T extrusion where the top portion of the T is solid and the remainder portion has a closed void for fluid flow. The top of this T extrusion may be stamped from the top to form cutouts that may fit the profile of the rows or the battery cells within the sheets. The close contact between the cells and the T extrusion cooling tube may provide low thermal resistance between the cells and the coolant. Still another contemplated optimized tube geometry may include a scallop tube 30 having an extruded fin extending from one edge of the body with locating holes that would aid in positioning of the cooling tube during manufacturing and assembly of the thermal management system within the energy storage system.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A battery pack thermal management system for use in an electric vehicle, said system including:
a manifold;
a plurality of cells arranged in a predetermined pattern in the battery pack; and
a cooling tube having a scalloped like outer surface in thermal contact with said cells.

2. The system of claim 1 wherein said scalloped like shape is arranged on each side of said cooling tube.

3. The system of claim 1 wherein said cooling tube is arranged between rows of said cells.

4. The system of claim 3 wherein adjacent rows of cells are offset by approximately one half of said cell spacing of one of said rows, a space between said cells is substantially filled by said cooling tube.

5. The system of claim 1 wherein said scallops having a predetermined inner radius that is approximately equal to an outer radius of said cells.

6. The system of claim 5 wherein said cells and said cooling tube generally have a predetermined nominal minimum spacing therebetewen.

7. The system of claim 1 wherein said cooling tube contours circumferentially along a surface of said cells at a constant offset until a minimum separation occurs between one of said cells and an adjacent said cell of an opposite row.

8. The system of claim 1 wherein said cooling tube having a high aspect ratio to minimize effect on an axial pitch between rows of said cells and maximize thermal contact of each said cell.

9. The system of claim 1 wherein said scallops are formed in a press using a die.

10. The system of claim 1 wherein said scallops are formed by moving a non scalloped cooling tube through a pair of rollers.

11. The system of claim 1 wherein said cooling tube having a plurality of channels arranged therein.

12. The system of claim 1 further including a thermal pad arranged between said cooling tube and said cells.

13. A thermal management system for use with an energy storage system in an electric vehicle, the energy storage system having a plurality of cells arranged into a plurality of sheets, wherein the sheets are housed inside an ESS enclosure, said thermal management system including:
a manifold secured to the ESS enclosure; and
a scalloped cooling tube arranged within each sheet, said cooling tube connected to said manifold, said cooling tube in thermal contact with the cells for temperature control of the cells during operation of the vehicle and mitigation of thermal runaway of the cells.

14. The thermal management system of claim 13 further including a deformable thermal pad arranged between said cooling tube and the cells.

15. The thermal management system of claim 13 wherein said cooling tube is arranged between rows of the cells.

16. The thermal management system of claim 15 wherein the cells in adjacent rows are offset by half the cell spacing in one row to provide for a space between said adjacent rows to be substantially filled by said cooling tube.

17. The thermal management system of claim 13 wherein said scallops having a predetermined inner radius that is substantially equivalent to an outer radius of the cell.

18. The thermal management system of claim 13 wherein said scallops having a generally circumferential bend that provides for a nominal minimum spacing between both sides of said cooling tube and the cells arranged next to each side of said cooling tube.

19. The thermal management system of claim 13 wherein said scallops are formed in a press with a die.

20. The thermal management system of claim 13 wherein said cooling tube having a plurality of channels arranged therein.

21. The thermal management system of claim 13 wherein the cells nest around said cooling tube to provide for close contact and close cell spacing resulting in low thermal resistance and low energy storage system density.
